(19) United States
(12) Patent Application Publication
(10) Pub. No.: US 2025/0088735 A1
(43) Pub. Date: Mar. 13, 2025

(54) IMAGE PICKUP APPARATUS, CONTROL METHOD, AND STORAGE MEDIUM

(71) Applicant: CANON KABUSHIKI KAISHA, Tokyo (JP)

(72) Inventor: YU INAGAKI, Tokyo (JP)

(21) Appl. No.: 18/760,252

(22) Filed: Jul. 1, 2024

(30) Foreign Application Priority Data
Sep. 8, 2023 (JP) 2023-146048

(51) Int. Cl. H04N 23/63; H04N 23/55; H04N 23/60; H04N 23/667; H04N 23/67; H04N 25/704

(52) U.S. Cl. CPC H04N 23/634; H04N 23/55; H04N 23/64; H04N 23/667; H04N 23/675; H04N 25/704

(57) ABSTRACT

An image pickup apparatus includes an image sensor having a plurality of focus detecting pixels configured to receive light beams that have passed through different pupil partial regions in an imaging optical system, a first focus detector configured to acquire a defocus amount of a first optical system based on a pair of signals from the focus detecting pixels, a second focus detector configured to acquire a defocus amount of a second optical system based on a pair of signals from the focus detecting pixels, and an alert unit configured to issue an alert to prompt adjustment of the first optical system or the second optical system in a case where a difference between the defocus amount of the first optical system and the defocus amount of the second optical system is larger than a first predetermined value.

### BACKGROUND

### Technical Field

One of the aspects of the embodiments relates to an image pickup apparatus, a control method, and a storage medium.

### Description of Related Art

Image pickup apparatuses configured to capture stereoscopically viewable images have recently been proposed (see Japanese Patent Laid-Open No. 2011-205558).

One conventional configuration includes two focus lenses, one of which is used to simultaneously adjust a right image formed via a right-eye optical system and a left image formed via a left-eye optical system, and the other of which is used to adjust one of the right or left image. This configuration can perform focusing during imaging using the focus lens configured to simultaneously adjust the left and right images, and adjust a difference between (the focus states of) the left-eye optical system and the right-eye optical system (referred to as a lateral difference hereinafter) in a case where a difference occurs between the left and right images using the focus lens configured to adjust one of the right or left image. A user is to visually recognize the lateral difference by comparing the left and right images using an enlarged display, etc., and thus has difficulty in visually recognizing the lateral difference during imaging.

A configuration having a focus lens configured to adjust a right image and a focus lens configured to adjust a left image is to constantly control two focus lenses, and in a case where a difference occurs between the respective focus detecting results, a lateral difference may occur during imaging and captured images may deteriorate.

### SUMMARY

An image pickup apparatus according to one aspect of the disclosure includes an image sensor having a plurality of focus detecting pixels configured to receive light beams that have passed through different pupil partial regions in an imaging optical system, a first focus detector configured to acquire a defocus amount of a first optical system based on a pair of signals from the focus detecting pixels, a second focus detector configured to acquire a defocus amount of a second optical system based on a pair of signals from the focus detecting pixels, and an alert unit configured to issue an alert to prompt adjustment of the first optical system or the second optical system in a case where a difference between the defocus amount of the first optical system and the defocus amount of the second optical system is larger than a first predetermined value.

A control method according to another aspect of the disclosure includes the steps of determining whether a difference between a defocus amount of a first optical system and a defocus amount of a second optical system is larger than a threshold, the first optical system and the second optical system being used for an image pickup apparatus, and issuing an alert in a case where the difference is larger than the threshold or reducing the difference by driving at least part of an imaging unit in a case where the difference is larger than the threshold. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B illustrate an example of the external configuration of a digital camera.

FIG. 2 illustrates an example of the internal configuration of the digital camera.

FIG. 3 is a schematic diagram illustrating an example configuration of a lens unit.

FIG. 4 is a schematic diagram illustrating an example pixel array of an image sensor in an imaging unit.

FIG. 5 is a flowchart illustrating lateral difference alert processing.

FIGS. 6A to 6D illustrate display examples of the lateral difference alert.

FIGS. 7A to 7D illustrate other display examples of the lateral difference alert.

FIG. 8 is a flowchart illustrating automatic lateral difference adjusting processing.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

This embodiment will discuss, as an example image pickup apparatus, a lens interchangeable type single-lens reflex digital camera having an autofocus (AF) function using an image-plane phase-difference method. The present disclosure is applicable to other image pickup apparatuses such as digital cameras and digital video cameras that are not a lens interchangeable type, personal computers (PCs), tablets as one type of PC, mobile phones, smartphones as one type of mobile phone, surveillance cameras, in-vehicle (on-board) cameras, and medical cameras.

### Overall Configuration

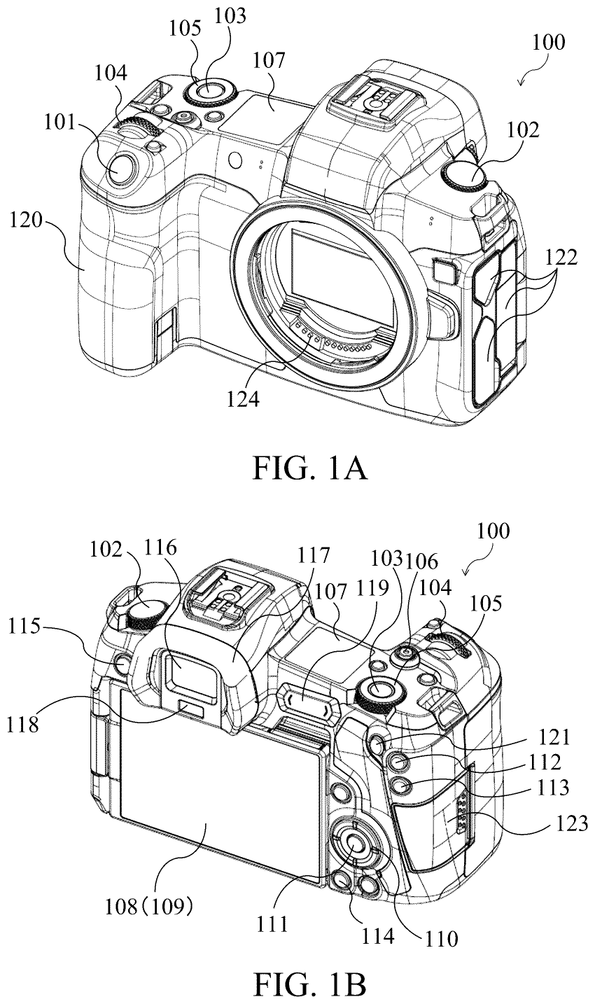

FIG. 1 illustrates an example of an external configuration of a digital camera (referred to as a camera hereinafter) 100. FIG. 1A is a perspective view of the camera 100 viewed from the front side, and FIG. 1B is a perspective view of the camera 100 viewed from the rear side.

The camera 100 includes a shutter button 101, a power switch 102, a mode switch 103, a main electronic dial 104, a sub electronic dial 105, a moving image button 106, and an extra-finder display unit 107 on the top surface. The shutter button 101 is an operation unit configured to provide an imaging preparation or imaging instruction. The power switch 102 is an operation unit configured to switch the power of the camera 100 on and off. The mode switch 103 is an operation unit configured to switch between various modes. The main electronic dial 104 is a rotary operation unit configured to change settings such as a shutter speed and an F-number (aperture value). The sub electronic dial 105 is a rotary operation unit configured to move a selection frame (cursor) and forwarding images. The moving image button 106 is an operation unit configured to instruct the start and stop of moving image capturing (recording). The extra-finder display unit 107 displays various settings such as a shutter speed and an F-number (aperture value).

The camera 100 includes a display unit 108, a touch panel 109, direction keys 110, a SET button 111, an auto-exposure (AE) lock button 112, an enlargement button 113, a playback button 114, and a menu button 115 on the rear surface of the camera 100. The camera 100 further includes an eyepiece unit 116 and an eyepiece finder (peer type viewfinder) 117 on the rear surface of the camera 100. The camera 100 further includes an eye proximity detector 118 and a touch bar 119 on the rear surface of the camera 100.

The display unit 108 displays images and various information. The touch panel 109 is an operation unit configured to detect a touch operation on the display surface (touch operation surface) of the display unit 108. The directional keys 110 form an operation unit having keys (four-direction keys) that can be pressed up, down, left, and right, and operations can be performed according to the position where the directional keys 110 are pressed. The SET button 111 is an operation unit that is pressed mainly to confirm a selection item. The AE lock button 112 is an operation unit that is pressed to fix an exposure state in an imaging standby state. The enlargement button 113 is an operation unit configured to switch the enlargement mode on and off in the live-view (LV) display in the imaging mode. In a case where the enlargement mode is turned on, the LV image is enlarged or reduced by operating the main electronic dial 104. The enlargement button 113 is also used to enlarge a playback image or increase the enlargement rate in the playback mode. The playback button 114 is an operation unit for switching between the imaging mode and the playback mode. In the imaging mode, pressing the playback button 114 switches to the playback mode, and enables the latest image recorded in a recording medium 228 described later to be displayed on the display unit 108.

The menu button 115 is an operation unit that is pressed to display a menu screen for various settings on the display unit 108. The user can intuitively make various settings using the menu screen displayed on the display unit 108, the directional keys 110, and the SET button 111. The eyepiece unit 116 is a part for placing the eye on the eyepiece finder 117. The user can visually recognize an image displayed on an electronic viewfinder (EVF) 217 inside the camera, described later, through the eyepiece unit 116. The eye proximity detector 118 is a sensor configured to detect whether the user has placed the eye on the eyepiece unit 116.

The touch bar 119 is a linear touch operation unit (line touch sensor) that can accept touch operations. The touch bar 119 is disposed at a position to be touch-operated (touchable) by the thumb of the right hand while the index finger of the right hand can press the shutter button 101 and a grip unit 120 is gripped by the right hand (with the little finger, ring finger, and middle finger of the right hand). That is, the touch bar 119 can be operated in an imaging attitude in which the user's eye is close to the eyepiece unit 116, the user peeps through the eyepiece finder 117, and the user holds the camera so as to press the shutter button 101. The touch bar 119 can accept a tap operation (operation of touching and releasing without moving within a predetermined period) and a lateral slide operation (operation of touching and then moving the touched position while keeping the touched position), etc. The touch bar 119 is an operation unit different from the touch panel 109, and does not have a display function. The touch bar 119 in this embodiment is a multi-function bar, and functions as, for example, an M-Fn bar.

The camera 100 further includes the grip unit 120, a thumb rest portion 121, a terminal cover 122, a lid 123, and a communication terminal 124. The grip unit 120 is a holder having a shape that is easy to hold with the right hand in a case where the user holds the camera 100. The shutter button 101 and the main electronic dial 104 are disposed so that the user can operate them with the index finger of the right hand in a case where the user holds the camera 100 by gripping the grip unit 120 with the little finger, ring finger, and middle finger of the right hand. The sub electronic dial 105 and the touch bar 119 are disposed so that the user can operate them with the thumb of the right hand in this state. The thumb rest portion 121 is a grip unit provided on the rear side of the camera 100 at a position where the user can easily place the thumb of the right hand holding the grip unit 120 while none of the operation units are being operated, and is made of a rubber material or the like for increasing holding power (grip feeling). The terminal cover 122 protects connectors such as a connection cable that connects the camera 100 to an external device. The lid 123 protects the recording medium 228 and the slot by closing the slot for storing the recording medium 228 described later. The communication terminal 124 is a terminal that is used for the camera 100 to communicate with the lens unit 200 described later, which is attachable to and detachable from the camera 100.

### Internal Configuration of Camera

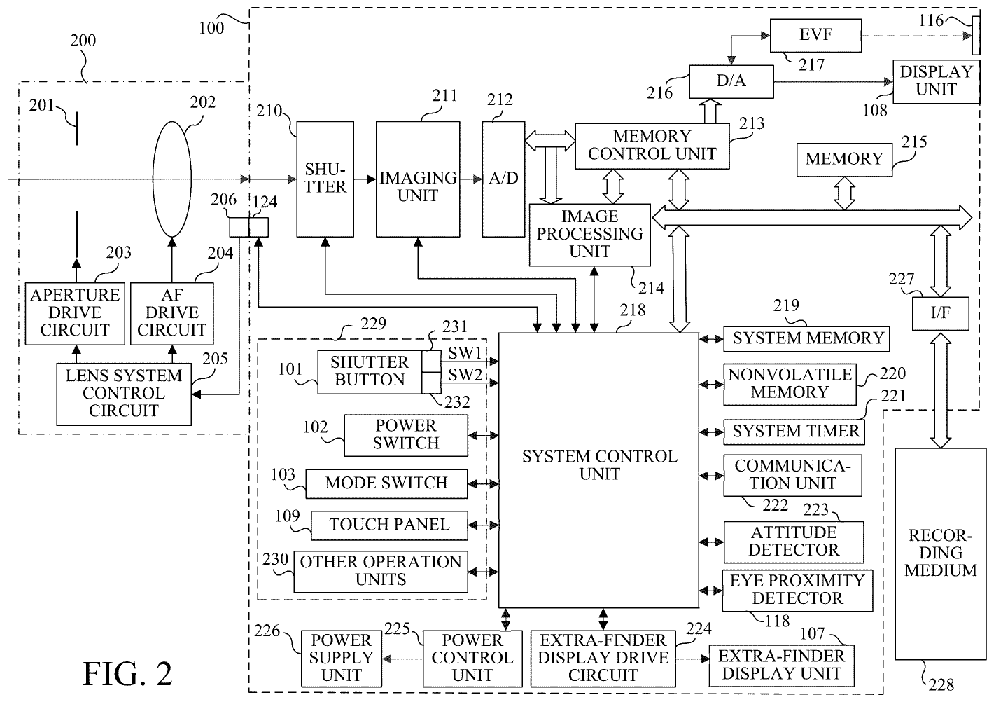

FIG. 2 illustrates an example internal structure of the camera 100. Those elements, which are corresponding elements in FIG. 1, will be designated by the same reference numerals, and a description thereof will be omitted. The lens unit 200 is attached to the camera 100.

The lens unit 200 will now be described. The lens unit 200 is a type of interchangeable lens that can be attached to and detached from the camera 100. The lens unit 200 is a single lens, and is an example normal lens. The lens unit 200 has an aperture stop 201, a lens 202, an aperture drive circuit 203, an AF drive circuit 204, a lens system control circuit (control apparatus) 205, and a communication terminal 206.

The aperture stop 201 has an adjustable aperture diameter. The lens 202 includes a plurality of lenses. The aperture drive circuit 203 adjusts a light amount by controlling the aperture diameter in the aperture stop 201. The AF drive circuit 204 drives the lens 202 for focusing. The lens system control circuit 205 controls the aperture drive circuit 203 and the AF drive circuit 204 based on instructions from a system control unit (control apparatus) 218, which will be described later. The lens system control circuit 205 controls the aperture stop 201 via the aperture drive circuit 203, and performs focusing by displacing the position of the lens 202 via the AF drive circuit 204. The lens system control circuit 205 can communicate with the camera 100. More specifically, communication is performed via the communication terminal 206 of the lens unit 200 and the communication terminal 124 of the camera 100. The communication terminal 206 is a terminal through which the lens unit 200 communicates with the camera 100.

Next, the camera 100 will be described. The camera 100 includes a shutter 210, an imaging unit 211, an A/D converter 212, a memory control unit 213, an image processing unit 214, a memory 215, a D/A converter 216, the EVF 217, the display unit 108, and a system control unit 218.

The shutter 210 is a focal plane shutter that can freely control the exposure time of the imaging unit 211 based on instructions from the system control unit 218. The imaging unit 211 includes an image sensor such as a CCD or CMOS element that converts an optical image into an electrical signal. The imaging unit may include an imaging optical system. The imaging unit 211 may further include an imaging-surface phase-difference sensor configured to output defocus amount information to the system control unit 218. The A/D converter 212 converts an analog signal output from the imaging unit 211 into a digital signal. The image processing unit 214 performs predetermined processing (pixel interpolation, resizing such as reduction, color conversion, etc.) for the data from the A/D converter 212 or the data from the memory control unit 213. The image processing unit 214 also performs predetermined calculation processing using captured image data, and the system control unit 218 performs exposure control and focus detection control based on the obtained calculation result. This processing provides through-the-lens (TTL) AF processing, AE processing, and electronic flash (pre-flash) processing. The image processing unit 214 performs predetermined calculation processing using the captured image data, and TTL auto white balance (AWB) processing based on the obtained calculation result.

The image data from the A/D converter 212 is written in the memory 215 via the image processing unit 214 and memory control unit 213. Alternatively, the image data from the A/D converter 212 is written in the memory 215 via the memory control unit 213 without passing through the image processing unit 214. The memory 215 stores image data obtained by the imaging unit 211 and converted into digital data by the A/D converter 212, and image data to be displayed on the display unit 108 and EVF 217. The memory 215 has a storage capacity sufficient to store a predetermined number of still images and a predetermined period of moving images and audio. The memory 215 also serves as an image display memory (video memory).

The D/A converter 216 converts the image display data stored in the memory 215 into an analog signal and supplies it to the display unit 108 and the EVF 217. Therefore, the display image data written in the memory 215 is displayed on the display unit 108 and the EVF 217 via the D/A converter 216. The display unit 108 and the EVF 217 perform display according to the analog signal from the D/A converter 216. The display unit 108 and the EVF 217 are, for example, display units such as an LCD or an organic EL. The digital signal that has been A/D-converted by the A/D converter 212 and stored in the memory 215 is converted into an analog signal by the D/A converter 216, is sequentially transferred to and displayed on the display unit 108 and the EVF 217, and thereby a LV display is performed.

The system control unit 218 is a control unit including at least one processor and/or at least one circuit. In other words, the system control unit 218 may be a processor, a circuit, or a combination of a processor and a circuit. The system control unit 218 controls the entire camera 100. The system control unit 218 executes a program recorded in a nonvolatile memory (NVM) 220 to realize each processing of the flowchart described later. The system control unit 218 also performs display control by controlling the memory 215, the D/A converter 216, the display unit 108, the EVF 217, etc.

The camera 100 further includes a system memory 219, the NVM 220, a system timer 221, a communication unit 222, an attitude detector 223, and the eye proximity detector 118.

The system memory 219 uses, for example, a RAM. The system memory 219 stores constants and variables for the operation of the system control unit 218, as well as programs read out of the NVM 220. The NVM 220 is an electrically erasable and recordable memory, such as, an EEPROM. Constants for the operation of the system control unit 218, programs etc. are recorded in the NVM 220. The programs here are programs for executing the flowcharts described later. The system timer 221 is a time measuring unit configured to measure the time used for various controls and the time of a built-in clock. The communication unit 222 transmits and receives video signals and audio signals to and from an external device connected wirelessly or by a wired cable. The communication unit 222 can also be connected to a wireless Local Area Network (LAN) and the Internet. The communication unit 222 can also communicate with external devices using Bluetooth (registered trademark) or Bluetooth Low Energy. The communication unit 222 can transmit images captured by the imaging unit 211 (including live-view images) and images recorded on the recording medium 228, and can receive images and other various information from the external devices. The attitude detector 223 detects the attitude (orientation) of the camera 100 relative to the gravity direction. Based on the attitude detected by the attitude detector 223, it is determined whether the image captured by the imaging unit 211 is an image captured with the camera 100 held horizontally or an image captured with the camera 100 held vertically. The system control unit 218 can add the attitude information according to the attitude detected by the attitude detector 223 to an image file of an image captured by the imaging unit 211, or rotate and record the image. For example, an acceleration sensor, a gyro sensor, or the like can be used for the attitude detector 223. Movement of the camera 100 (panning, tilting, lifting, whether it is stationary, etc.) can be detected using the attitude detector 223.

The eye proximity detector 118 can detect the proximity of an object to the eyepiece unit 116 of the eyepiece finder 117 including the EVF 217. For example, an infrared proximity sensor can be used as the eye proximity detector 118. In a case where an object approaches the eye proximity detector, infrared light emitted from a light projector in the eye proximity detector 118 is reflected by the object and is received by a light receiver of the infrared proximity sensor. The distance from the eyepiece unit 116 to the object can be determined based on the received infrared ray amount. Thus, the eye proximity detector 118 performs eye proximity detection to detect the proximity distance of an object to the eyepiece unit 116 of the eyepiece finder 117. The eye proximity detector 118 is an eye proximity detection sensor that detects the approach and separation of the eye (object) from the eyepiece unit 116. In a case where an object is detected that approaches the eyepiece unit 116 within a predetermined distance from the non-proximity state, it is detected that the object is close to the eyepiece unit 116. On the other hand, in a case where the object whose approach was detected moves away from the proximity state (approach state) by a predetermined distance or more, it is detected that the eye has separated from the eye. A threshold for detecting the proximity and a threshold for detecting the separation may be different to provide hysteresis, for example. After the eye proximity is detected, the eye proximity is assumed unless eye separation is detected. After eye separation is detected, the eye separation state is assumed unless eye proximity is detected. The system control unit 218 switches the display unit 108 and the EVF 217 between the display (display state) and non-display (non-display state) according to the state detected by the eye proximity detector 118. More specifically, in a case where the camera is at least in an imaging standby state and the display destination switching setting is automatically switchable, the display destination during non-eye proximity is set to the display unit 108, display of the display unit 108 is turned on and display of the EVF 217 is turned off. During eye proximity, the display destination is set to the EVF 217, the display of the EVF 217 is turned on, and display of the display unit 108 is turned off. The eye proximity detector 118 is not limited to an infrared proximity sensor, and another sensor may be used as long as it can detect a state that can be considered to be eye proximity.

The camera 100 further includes the extra-finder display unit 107, an extra-finder display drive circuit 224, a power control unit 225, a power supply unit 226, a recording medium I/F 227, and an operation unit 229. The extra-finder display unit 107 displays various settings of the camera 100, such as a shutter speed and an F-number, via the extra-finder display drive circuit 224. The power control unit 225 includes a battery detecting circuit, a DC-DC converter, and a switch circuit for switching between blocks to be energized, and detects whether a battery is attached, the type of battery, and the remaining battery level. The power control unit 225 also controls the DC-DC converter based on the detection result and instruction from the system control unit 218, and supplies the required voltage to each unit including the recording medium 228 for the required period. The power supply unit 226 includes a primary battery such as an alkaline battery or a lithium battery, a secondary battery such as a NiCd battery, a NiMH battery, or a Li battery, an AC adapter, and the like. The recording medium I/F 227 is an interface with the recording medium 228, such as a memory card or a hard disk drive. The recording medium 228 is a memory card or the like for recording captured images, and includes a semiconductor memory, a magnetic disk, or the like. The recording medium 228 may be removable or built-in.

The operation unit 229 is an input unit that accepts operations from the user (user operations), and is used to input various instructions to the system control unit 218. The operation unit 229 includes the shutter button 101, the power switch 102, the mode switch 103, the touch panel 109, and other operation units 230. The other operation units 230 include the main electronic dial 104, the sub electronic dial 105, the moving image button 106, the directional keys 110, the SET button 111, the AE lock button 112, the enlargement button 113, the playback button 114, the menu button 115, the touch bar 119, and the like.

The shutter button 101 includes a first shutter switch 231 and a second shutter switch 232. The first shutter switch 231 is turned on when the shutter button 101 is half-pressed (imaging preparation instruction) and generates a first shutter switch signal SW1. The system control unit 218 starts image preparation processing, such as AF processing, AE processing, AWB processing, and EF processing, by the first shutter switch signal SW1. The second shutter switch 232 is turned on when the shutter button 101 is fully pressed (imaging instruction) and generates a second shutter switch signal SW2. The system control unit 218 starts a series of imaging processing, from reading a signal from the imaging unit 211 to generating an image file including a captured image and writing it in the recording medium 228, by the second shutter switch signal SW2.

The mode switch 103 switches the operation mode of the system control unit 218 to any one of still image capturing mode, moving image capturing mode, playback mode, etc. Modes included in the still image capturing mode include an automatic imaging mode, an automatic scene discrimination mode, a manual mode, an aperture priority mode (Av mode), a shutter speed priority mode (Tv mode), and a program AE mode (P mode). There are various scene modes, custom modes, etc. that provide imaging settings for each imaging scene. The user can directly switch to any of the above imaging modes using the mode switch 103. The user can switch to the imaging mode list screen using the mode switch 103, and then selectively switch to any of the displayed modes using the operation unit 229. Similarly, the moving image capturing mode may also include a plurality of modes.

The touch panel 109 is a touch sensor that detects various touch operations on the display surface of the display unit 108 (the operation surface of the touch panel 109). The touch panel 109 and the display unit 108 can be integrated. For example, the touch panel 109 is attached to an upper layer of the display surface of the display unit 108 so that the light transmittance does not interfere with the display on the display unit 108. Associating the input coordinates on the touch panel 109 with the display coordinates on the display surface of the display unit 108 can form a graphical user interface (GUI) as if the user could directly operate the screen displayed on the display unit 108. The touch panel 109 can use any one of various methods, such as a resistive film method, a capacitive method, a surface acoustic wave method, an infrared method, an electromagnetic induction method, an image recognition method, and an optical sensor method. Depending on the method, methods can be used that detect a touch when there is contact with the touch panel 109, and when a finger or pen approaches the touch panel 109, but any method can be used.

The system control unit 218 can detect the following operations or states on the touch panel 109:
A finger or a pen that has not touched the touch panel 109 newly touches the touch panel 109, that is, the start of a touch (referred to as Touch-down hereinafter):
A state in which the touch panel 109 is touched with a finger or a pen (referred to as Touch-on hereinafter);
A finger or pen that has touched the touch panel 109 moves away from the touch panel 109 (referred to as Touch-move hereinafter);
A finger or pen that has touched the touch panel 109 is removed from the touch panel 109 (released), that is, the touch ends (referred to as Touch-up hereinafter); and
A state in which nothing is touched on the touch panel 109 (referred to as Touch-off hereinafter).

In a case where Touch-down is detected, Touch-on is also detected at the same time. After Touch-down is made, Touch-on typically continues to be detected unless Touch-up is detected. In a case where Touch-move is detected, Touch-on is also detected at the same time. Even if Touch-on is detected, if the touch position does not move, Touch-move is not detected. After all touching fingers or pens are detected to have touched-up, Touch-off occurs.

These operations/states and the coordinates of the position where the finger or pen is touching on the touch panel 109 are notified to the system control unit 218 through the internal bus. The system control unit 218 determines what kind of operation (touch operation) has been performed on the touch panel 109 based on the notified information. Regarding touch movements, a moving direction of a finger or pen on the touch panel 109 can also be determined for each vertical component and horizontal component on the touch panel 109 based on changes in position coordinates. In a case where it is detected that a touch move has been made over a predetermined distance, it is determined that a slide operation has been performed.

A flick is an operation in which a finger touching the touch panel 109 quickly moves a certain distance, and then releases. In other words, the flick is an operation in which a finger is quickly traced on the touch panel 109 as if it flicks. In a case where Touch-move is detected over a predetermined distance and at a predetermined speed or higher, and Touch-up is detected as it is, it is determined that a flick has been performed (it can be determined that a flick has occurred following a slide operation). A pinch-in is a touch operation in which multiple points (such as two points) are touched together (multi-touch) and the touch positions are brought closer to each other, and a pinch-out is a touch operation in which the touch positions are moved away from each other. Pinch-out and pinch-in are collectively called a pinch operation (or simply pinch).

### Configuration of Lens Unit

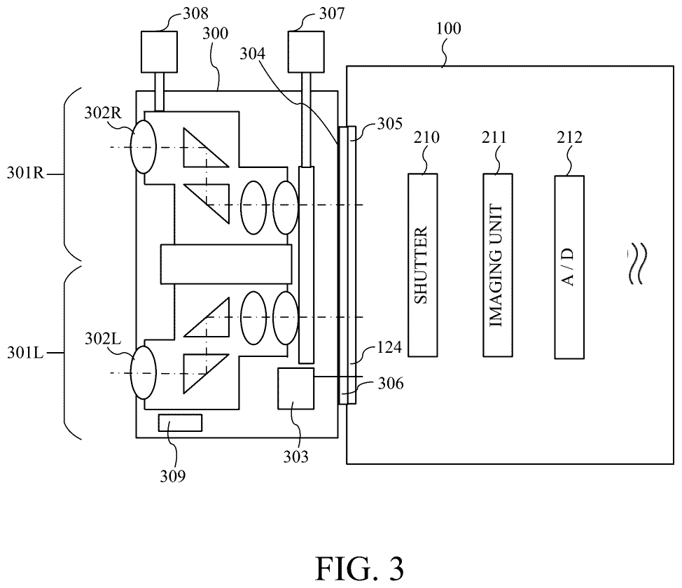

FIG. 3 is a schematic diagram illustrating an example configuration of the lens unit 300. FIG. 3 illustrates the lens unit 300 attached to the camera 100. Those elements, which are corresponding elements in FIG. 2 in the camera 100 illustrated in FIG. 3, will be designated by the same reference numerals, and a description thereof will be omitted.

The lens unit 300 is a type of interchangeable lens that can be attached to and detached from the camera 100. The lens unit 300 is a twin-lens that can perform imaging with parallax between left and right images. The lens unit 300 includes two optical systems, each with a wide angle of field of approximately 180 degrees, and can perform imaging in a range of the front hemisphere. More specifically, the two optical systems in the lens unit 300 can capture an object with an angle of field (angle of view) of 180 degrees in the horizontal direction (horizontal angle, azimuth angle, yaw angle) and 180 degrees in the vertical direction (vertical angle, elevation angle, pitch angle).

The lens unit 300 includes a right-eye optical system 301R having a plurality of lenses and a mirror, a left-eye optical system 301L having a plurality of lenses and a mirror, a lens system control circuit 303, a lens mount unit 304, and a communication terminal 306. The right-eye optical system 301R corresponds to one of the first optical system and the second optical system, and the left-eye optical system 301L corresponds to the other of the first optical system and the second optical system. In the right-eye optical system 301R and the left-eye optical system 301L, the lenses 302R and 302L located on the object side face in the same direction, and their optical axes are approximately parallel. The lens unit 300 in this embodiment is a virtual reality (VR)180 lens for capturing a image for so-called VR180, which is a VR image format that allows twin-eye stereoscopic view. The VR180 lens includes fisheye lenses that allow the right-eye optical system 301R and the left-eye optical system 301L to capture a range of approximately 180 degrees. The VR180 lens may be a lens capable of capturing a wide angle-of-field range of about 160 degrees, which is narrower than the 180-degree range, as long as it can obtain images that allow the right-eye optical system 301R and the left-eye optical system 301L to display in twin-eye VR as VR180. The VR180 lens can form a right image (first image) formed via the right-eye optical system 301R and a left image (second image) formed via the left-eye optical system 301L, which has parallax from the right image, on a single image sensor of the attached camera.

The lens unit 300 further includes motors 307 and 308 that perform focusing, and a switch (mode switch) 309. The motor 307 performs focusing for a right image formed via the right-eye optical system 301R and a left image formed via the left-eye optical system 301L simultaneously. The motor 308 performs focusing for the right image formed via the right-eye optical system 301R or the left image formed via the left-eye optical system 301L. The switch 309 can switch between driving of the motor 307 and driving of the motor 308. By driving the motor 308, a mode is switched to an adjustment mode that adjust a difference between the left-eye optical system 301L and the right-eye optical system 301R (i.e., lateral difference).

The lens unit 300 is attached to the camera 100 via the lens mount unit 304 and the camera mount unit 305 of the camera 100. By attaching the lens unit 300 to the camera 100, the system control unit 218 and the lens system control circuit 303 are electrically connected via the communication terminals 124 and 306. In this embodiment, the right image formed via the right-eye optical system 301R and the left image formed via the left-eye optical system 301L, which has parallax from the right image, are formed side by side in the imaging unit 211. That is, two optical images formed by the right-eye optical system 301R and the left-eye optical system 301L are formed on the single image sensor. The imaging unit 211 converts the object images (optical signals) into an analog electrical signals. In this way, by using the lens unit 300, two images with parallax can be simultaneously acquired (as a set) from two (optical systems), i.e., the right-eye optical system 301R and the left-eye optical system 301L. In addition, by dividing the acquired images into a left-eye image and a right-eye image and VR-displaying them, the user can view a stereoscopic VR image with a range of approximately 180 degrees, so-called VR180.

Here, the VR image is a VR-displayable image, which will be described later. The VR image includes an omnidirectional image captured by an omnidirectional camera, a panoramic image having a wider image range (effective image range) than a display range that can be displayed at one time on the display unit, and the like. In addition, the VR image is not limited to a still image, and includes a moving image and a live-view image (an image obtained from a camera in almost real time). The VR image has an image range (effective image range) of a field of 360 degrees in the lateral direction and 360 degrees in the vertical direction at a maximum. In addition, the VR image further includes an image having an angle of view wider than an angle of view imageable by a normal camera, or wider than a display range displayable at one time on the display unit, even if it is less than 360 degrees in the lateral direction or less than 360 degrees in the vertical direction. The image captured by the camera 100 using the lens unit 300 described above is one type of VR image. The VR image can be VR-displayed, for example, by setting a display mode of a display apparatus (that can display a VR image) to “VR view.” By displaying a VR image with an angle of view of 360 degrees and changing the attitude (or orientation) of the display apparatus in the lateral direction (horizontal rotation direction), the user can view a seamless omnidirectional image in the lateral direction.

Here, VR display (VR view) is a display method (display mode) that displays an image of a VR image with a field range according to the attitude of the display apparatus, and can change the display range. VR display includes “single-eye VR display (single-eye VR view),” which displays a single image by performing a transformation (transformation that performs distortion correction) that maps the VR image onto a virtual sphere. VR display further includes “twin-eye VR display (twin-eye VR view),” which displays a left-eye VR image and a right-eye VR image side by side in left and right areas by performing a transformation that maps the left-eye VR image and the right-eye VR image, respectively, onto a virtual sphere. Stereoscopic viewing is possible by performing “twin-eye VR display” using a left-eye VR image and a right-eye VR image, which have parallax from each other. No matter which VR display is used, for example, in a case where a user wears a display apparatus such as a head mount display (HMD), an image with a field range according to the attitude of the user's face is displayed. For example, assume that an image with a field range centered on 0 degrees in the lateral direction (a specific azimuth, such as north) and 90 degrees in the vertical direction (90 degrees from the zenith, that is, horizon) is displayed in a VR image at a certain time. In a case where the attitude of the display apparatus is reversed from this state (for example, the display surface is changed from facing south to facing north), the display range is changed to an image with a field range centered on 180 degrees in the lateral direction (the opposite azimuth, for example, south) and 90 degrees in the vertical direction in the same VR image. That is, in a case where a user wears an HMD and turns his face from north to south (i.e., turns back), the image displayed on the HMD is also changed from a north image to a south image. The VR image captured using the lens unit 300 according to this embodiment is a VR180 image of a front range of approximately 180 degrees, and there is no image with a back range of approximately 180 degrees. In a case where such an image of VR180 is VR-displayed and the attitude of the display apparatus is changed to a side where no image exists, a blank area is displayed.

By VR-displaying a VR image in this way, the user feels as if he is visually inside the VR image (inside the VR space). The method of displaying the VR image is not limited to a method of changing the attitude of the display apparatus. For example, the display range may be moved (scrolled) according to a user operation via a touch panel or directional button. During VR display (in a case where the display mode is “VR view”), in addition to changing the display range due to the attitude change, the display range may be changed according to touch-move on the touch panel, dragging with a mouse, pressing a directional button, etc. A smartphone attached to VR goggles (head mount adapter) is one type of HMD.

### Configuration of Image Sensor in Imaging Unit

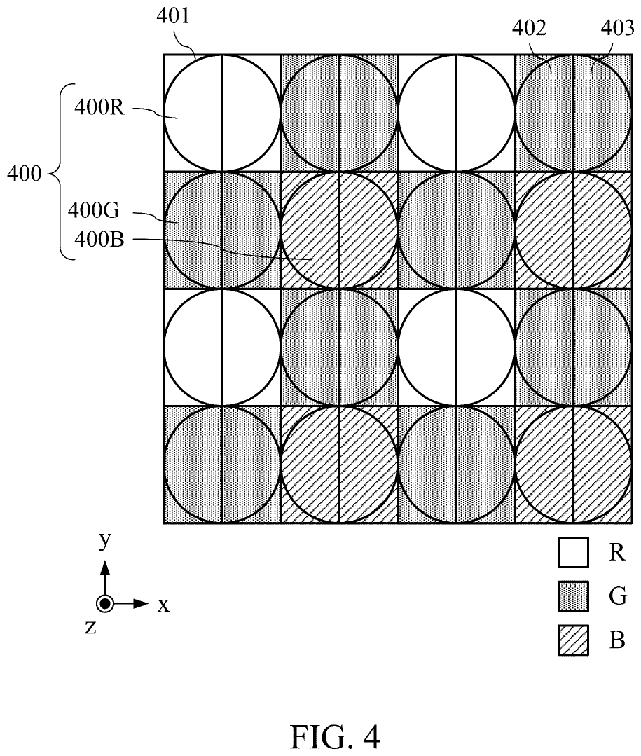

FIG. 4 is a schematic diagram illustrating an example pixel array of the image sensor in the imaging unit 211. In FIG. 4, the pixel array of the two-dimensional CMOS sensor that is used as the image sensor is illustrated in a range of 4 columns×4 rows of imaging pixels (8 columns×4 rows as an array of focus detecting pixels). The focus detecting pixels are pixels configured to receive light beams that pass through different pupil regions of the imaging optical system.

In this embodiment, a pixel group 400 includes pixels arranged in 2 columns×2 rows, and is covered with color filters in a Bayer array. In the pixel group 400, a pixel 400R having a spectral sensitivity of R (red) is disposed at the upper left position, a pixel 400G having a spectral sensitivity of G (green) is disposed at the upper right and lower left positions, and a pixel 400B having a spectral sensitivity of B (blue) is disposed at the lower right position. In order for the image sensor to perform focus detection using the imaging-surface phase-difference method, each pixel holds a plurality of photodiodes (photoelectric converters) for one microlens 401. In this embodiment, each pixel includes photodiodes 402 and 403 arranged in 2 columns×1 row.

The image sensor can acquire imaging signals and focus detecting signals by arranging a large number of pixel groups 400 consisting of 2 columns×2 rows of pixels (4 columns×2 rows of photodiodes) on the imaging surface.

In each pixel having such a configuration, the light beams are separated by the microlens 401 and an image is formed on each of the photodiodes 402 and 403. Then, a signal (A+B signal) obtained by adding the signals from the photodiodes 402 and 403 is used as an imaging signal, and a pair of focus detecting signals (A and B image signals) read out of the photodiodes 402 and 403 are used as a focus detecting signal. The imaging signal and the focus detecting signal may be read out separately, but in consideration of the processing load, the following may be used. That is, the imaging signal (A+B signal) and one of the focus signals (e.g., A signal) of the photodiodes 402 and 403 may be read out and a difference may be taken to obtain the other focus detecting signal (e.g., B signal).

In this embodiment, each pixel has the photodiodes 402 and 403 for one microlens 401, but the number of photodiodes is not limited to two and may be more than two. A plurality of pixels having different opening positions of the light receiving parts for the microlens 401 may be provided. In other words, any configuration may be used as long as two phase-difference detecting signals, such as the A image signal and the B image signal.

While FIG. 4 illustrates a configuration in which all pixels have a plurality of photodiodes, this embodiment is not limited, and focus detecting pixels may be provided discretely within the normal pixels that form the image sensor.

### Lateral Difference Alert

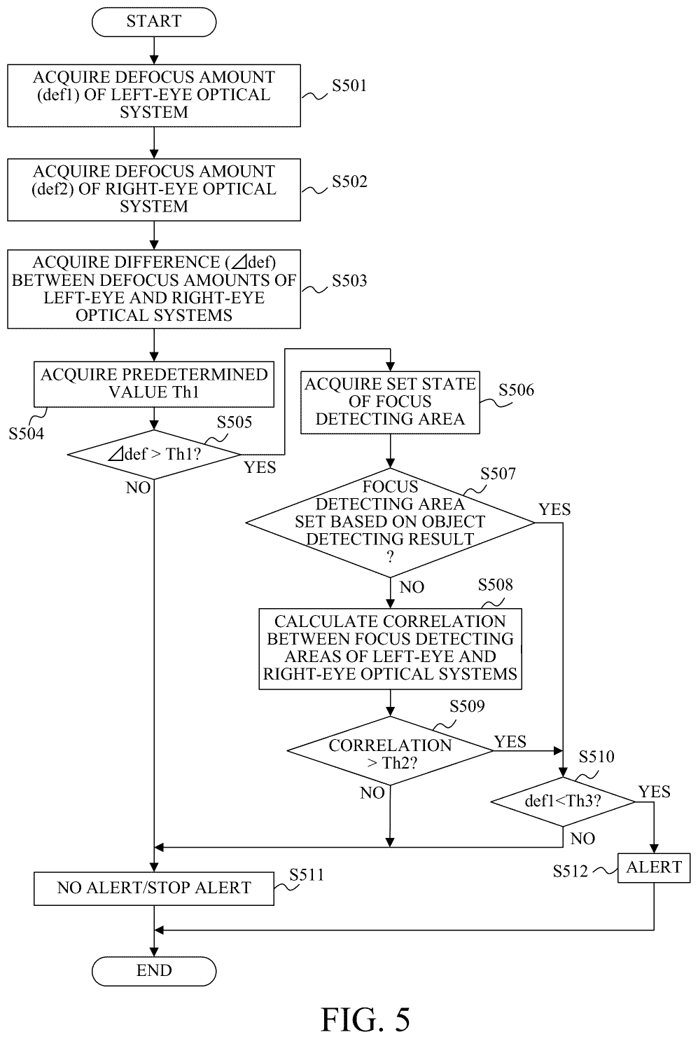

FIG. 5 is a flowchart illustrating lateral difference alert processing.

In step S501, the system control unit (first focus detector) 218 acquires a defocus amount (def1) of the left-eye optical system 301L.

In step S502, the system control unit (second focus detector) 218 acquires a defocus amount (def2) of the right-eye optical system 301R.

The order of steps S501 and S502 may be reversed.

In step S503, the system control unit 218 acquires a difference (Δdef) between the defocus amount of the left-eye optical system 301L and the defocus amount of the right-eye optical system 301R from the defocus amounts (def1, def2) acquired in steps S501 and S502.

In step S504, the system control unit (setting unit) 218 acquires a predetermined value (first predetermined value, threshold) Th1. The predetermined value Th1 is a previously set value, and is used to determine whether or not to issue an alert (notification or alarm) in a case where there is a difference between the defocus amounts of the left-eye optical system 301L and the right-eye optical system 301R. Although the predetermined value Th1 is a previously set value in this embodiment, the user may set it from a menu screen. The predetermined value Th1 may also be set according to the state of the camera 100. For example, the predetermined value Th1 during standby may be set smaller than that during imaging so that the user can easily recognize the lateral difference before imaging starts, or the predetermined value Th1 may be set larger in a case where there is camera shake or during moving image capturing, because the image is easily affected by focus detecting error. This embodiment is not limited to the above example, the predetermined value Th1 may be changed according to a parameter such as an imaging distance and an F-number. In order to prevent an alert state from changing frequently, the predetermined value Th1 may be set small while alert is in progress.

In step S505, the system control unit 218 determines whether the difference (Δdef) between the defocus amounts of the left-eye optical system 301L and the right-eye optical system 301R calculated in step S503 is larger than the predetermined value Th1 acquired in step S504. In a case where the system control unit 218 determines that the difference (Δdef) in the defocus amount is larger than the predetermined value Th1, the flow proceeds to step S506, and in a case where the system control unit 218 determines that the difference (Δdef) is smaller than the predetermined value Th1, the flow proceeds to step S511. In a case where the difference (Δdef) is equal to the predetermined value Th1, which step is to be executed may be arbitrarily set.

In step S506, the system control unit 218 acquires the set state of the focus detecting area. In a case where the reliability of the object detecting result detected by the system control unit (object detector) 218 is high, the focus detecting area is set based on the object detecting result, and in a case where the reliability is low, the focus detecting area is set based on previously set focus frames (601R and 601L described later). The object detecting result is the position, size, etc. of the object.

In step S507, the system control unit 218 determines whether the focus detecting area is set based on the object detecting result. In a case where the focus detecting area is set based on the object detecting result, it is unlikely that the difference in the defocus amount is large because the object in the focus detecting area is different between the left and right due to the influence of parallax, etc. On the other hand, in a case where the focus detecting area is not set based on the object detecting result, it is likely that the object in the focus detecting area is different between the left and right. In a case where the system control unit 218 determines that the focus detecting area is set based on the object detecting result, the flow proceeds to step S510, and in a case where it determines that the focus detecting area is not set based on the object detecting result, the flow proceeds to step S508.

In step S508, the system control unit 218 acquires image signals from the focus detecting areas of the left-eye optical system 301L and the right-eye optical system 301R, and calculates the correlation (degree) between the focus detecting area of the left-eye optical system 301L and the focus detecting area of the right-eye optical system 301R.

In step S509, the system control unit 218 determines whether the correlation calculated in step S508 is larger than a predetermined value (second predetermined value) Th2. In a case where the system control unit 218 determines that the correlation is larger than the predetermined value Th2, the flow proceeds to step S510, and in a case where it determines that the correlation is smaller than the predetermined value Th2, the flow proceeds to step S511. In a case where the correlation is equal to the predetermined value Th2, which step is to be executed may be arbitrarily set. The predetermined value Th2 is a previously set value in this embodiment, but the user may set it from a menu screen, or it may be set according to the state of the camera 100.

In step S510, the system control unit 218 determines whether the defocus amount (def1) of the left-eye optical system 301L acquired in step S501 is smaller than a predetermined value (third predetermined value) Th3. In a case where the system control unit 218 determines that the defocus amount (def1) is smaller than the predetermined value Th3, the flow proceeds to step S512, and in a case where it determines that the defocus amount (def1) is larger than the predetermined value Th3, the flow proceeds to step S511. In a case where the defocus amount (def1) is equal to the predetermined value Th3, which step is to be executed may be arbitrarily set. The predetermined value Th3 is a previously set value in this embodiment, but the user may set it from a menu screen, or it may be set according to the state of the camera 100. In this embodiment, the left-eye optical system 301L is used as the reference, but this embodiment is not limited to this example, and the right-eye optical system 301R may be used as the reference and the defocus amount (def2) of the right-eye optical system 301R may be compared with the predetermined value Th3.

In step S511, in a case where the system control unit 218 has not issued an alert, the flow ends without the alert, and in a case where the system control unit 218 is issuing an alert, it stops the alert and the flow ends.

In step S512, the system control unit (alert unit) 218 issues a lateral difference alert. The lateral difference adjustment is made by comparing the left and right images, and thus may be performed in an in-focus state. Therefore, in a case where the left-eye optical system 301L as a reference is in an in-focus state, an alert is issued to prompt the user to adjust the lateral difference.

### Alert Display

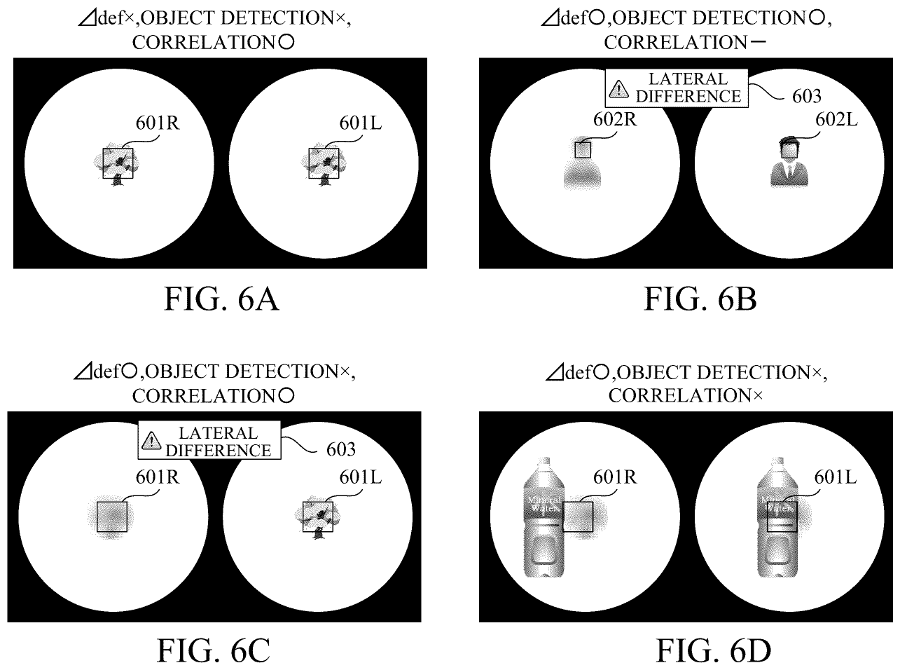

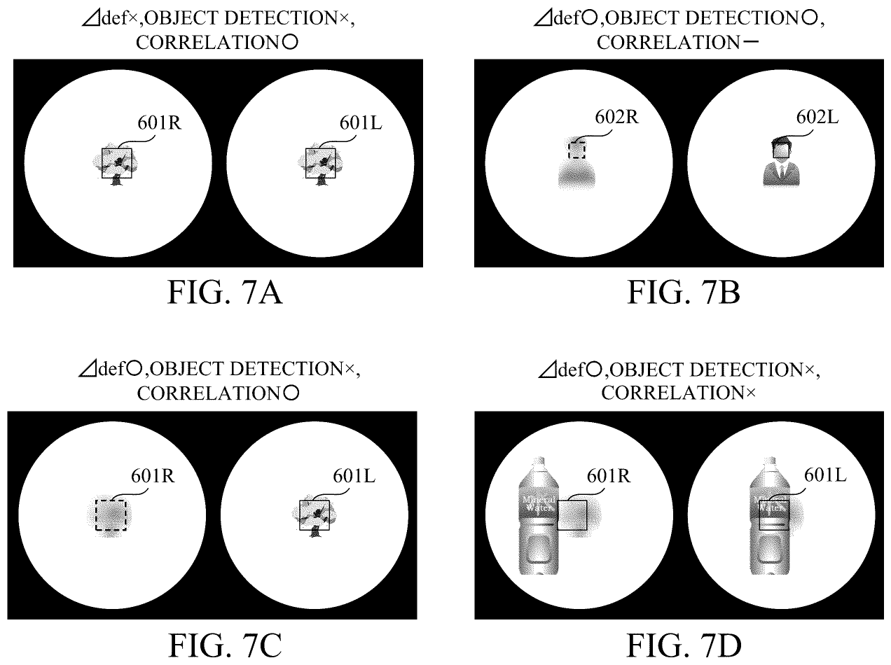

FIGS. 6A to 7D illustrate display examples of the lateral difference alert according to the state of the object. FIGS. 6A to 7D illustrate different display examples.

In FIGS. 6A and 7A, the difference Δdef is smaller than the predetermined value Th1, the focus detecting area is set based on the focus frames 601L and 601R, rather than the object detecting result, and the lateral correlation is larger than the predetermined value Th2. In this case, due to the determination in step S505 in FIG. 5, the lateral difference alert processing ends without alert, so no alert is displayed.

In FIGS. 6B and 7B, the difference Δdef is larger than the predetermined value Th1, and the focus detecting area is set based on the object detection areas 602L and 602R of the object detecting result. In this case, an alert is issued after the determination in steps S505 and S507 in FIG. 5. In FIG. 6B, an alert is issued by displaying an alert icon 603, and in FIG. 7B, an alert is issued by changing the display of the focus frame 601R to a dotted line. The alert method is not limited to this example, and an alert may be performed by simultaneously displaying the icon and changing a display of at least one of a focus detecting area of the first focus detector and a focus detecting area of the second focus detector, such as changing the color of the focus frame (focus detecting area), and blinking the focus frame (focus detecting area).

In FIGS. 6C and 7C, the difference Δdef is larger than the predetermined value Th1, the focus detecting area is set based on focus frames 601L and 601R rather than the object detecting result, and the correlation is larger than the predetermined value Th2. In this case, an alert is issued after the determinations of steps S505, S507, and S509 in FIG. 5. In FIGS. 6C and 7C, an alert is issued in the same manner as in FIGS. 6B and 7B, respectively.

In FIGS. 6D and 7D, the difference Δdef is larger than the predetermined value Th1, the focus detecting area is set based on focus frames 601L and 601R rather than the object detecting result, and the correlation is smaller than the predetermined value Th2. In this case, no alert is displayed after the determinations of steps S505, S507, and S509 in FIG. 5. Thus, by using the correlation to determine whether the objects in the focus detecting areas are the same between the left and right, the difference in defocus amount caused by focus detection for different objects on the left and right can be eliminated, and an alert can be prevented in a case where the lateral difference adjustment is not necessary.

As described above, in a case where the difference between focus detecting results of left and right images is larger than a predetermined value and the focus detecting area satisfies various conditions, this embodiment issues an alert to prompt the user to adjust the lateral difference. By alerting the user to prompt the lateral difference adjustment, the user can correctly recognize that there is a lateral difference to be adjusted, and can perform the lateral difference adjustment, so that the lateral difference can be eliminated without affecting captured images.

### Automatic Lateral Difference Adjustment

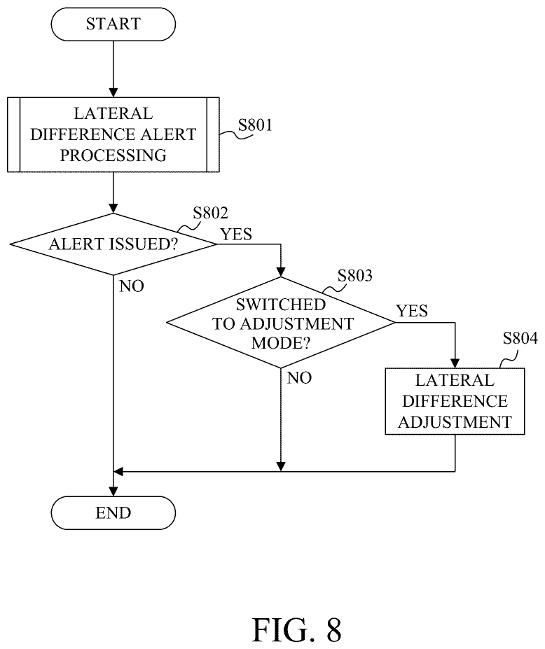

FIG. 8 is a flowchart illustrating automatic lateral difference adjusting processing.

In step S801, the system control unit 218 executes the lateral difference alert processing of FIG. 5.

In step S802, the system control unit 218 determines whether or not there is an alert as a result of the lateral difference alert processing executed in step S801. In a case where the system control unit 218 determines that there is the alert, the flow proceeds to step S803, and in a case where it determines that there is no alert, the flow ends.

In step S803, the system control unit 218 determines whether the switch 309 has been operated and the mode is switched to the adjustment mode. In a case where the system control unit 218 determines that the mode has been switched to the adjustment mode, the flow proceeds to step S804, and in a case where it determines that the mode has not been switched to the adjustment mode, the flow ends.

In step S804, the system control unit 218 drives the motor 308 based on the difference Δdef acquired in step S503, and adjusts the lateral difference.

Thus, in a case where the mode is switched to the adjustment mode while a lateral difference alert is being issued, the user can recognize the lateral difference through the alert and the switched adjustment mode automatically performs the lateral difference adjustment based on the detected lateral difference. Thereby, the lateral difference can be adjusted without any additional action by the user.

While the disclosure has described example embodiments, it is to be understood that some embodiments are not limited to the disclosed embodiments. The scope of the following claims is to be accorded the broadest interpretation so as to encompass all such modifications and equivalent structures and functions.

As discussed, the system control unit 218 serves as a control apparatus that executes control methods illustrated in FIGS. 5 and 8. A non-transitory computer-readable storage medium storing a program that causes a computer to execute each of the above control methods also constitutes another aspect of the disclosure. For example, the control apparatus includes an acquiring unit configured to acquire information about def1, def2, Δdef, and Th1 (steps S501 to S503), a determining unit configured to determine whether Δdef is larger Th1 (S505), and an alert unit configured to issue an alert in a case where Δdef is larger Th1 (S512). In addition, the control apparatus includes an adjuster configured to reduce the difference in a case where Δdef is larger Th1 (S804). S804 may be implemented without an alert. That is, in a case where the flow proceeds to Yes from step S510, S803 may be determined without S512 or S802. The adjuster is not limited to driving the motor 308 (lens 202), and may drive (move, pan, tilt, or rotate) the image sensor instead of or in addition to driving the motor 308. As described above, the imaging unit may include the imaging optical system. Therefore, the adjuster may reduce the difference by driving at least part of the imaging unit. The lens system control circuit 205 may serve as the control apparatus instead of or in cooperation with the system control unit 218. The control apparatus may be configured as a remote control apparatus separate from an optical apparatus (image pickup apparatus, lens apparatus). For example, the control apparatus may be provided to a remote controller for a drone.

This embodiment can provide an image pickup apparatus, a control method, and a storage medium, each of which can eliminate a difference between left and right without affecting a captured image.

This application claims priority to Japanese Patent Application No. 2023-146048, which was filed on Sep. 8, 2023, and which is hereby incorporated by reference herein in its entirety.

What is claimed is:

1. An image pickup apparatus comprising:
an image sensor having a plurality of focus detecting pixels configured to receive light beams that have passed through different pupil partial regions in an imaging optical system;
a first focus detector configured to acquire a defocus amount of a first optical system based on a pair of signals from the focus detecting pixels;
a second focus detector configured to acquire a defocus amount of a second optical system based on a pair of signals from the focus detecting pixels; and
an alert unit configured to issue an alert to prompt adjustment of the first optical system or the second optical system in a case where a difference between the defocus amount of the first optical system and the defocus amount of the second optical system is larger than a first predetermined value.

2. The image pickup apparatus according to claim 1, wherein the alert unit issues the alert in a case where a correlation between a focus detecting area of the first focus detector and a focus detecting area of the second focus detector is larger than a second predetermined value.

3. The image pickup apparatus according to claim 2, wherein at least one of the first predetermined value and the second predetermined value is set according to a state of the image pickup apparatus.

4. The image pickup apparatus according to claim 1, further comprising an object detector configured to detect a position and size of an object,
wherein the alert unit issues the alert in a case where a focus detecting area of the first focus detector and a focus detecting area of the second focus detector are set by a detection result of the object detector.

5. The image pickup apparatus according to claim 1, wherein the image pickup apparatus is configured to perform a live-view display using a captured image, and
wherein the alert unit issues the alert on the live-view display.

6. The image pickup apparatus according to claim 1, wherein in a case where the difference is larger than the first predetermined value, the alert unit makes different at least one of a display of the focus detecting area of the first focus detector and a display of the focus detecting area of the second focus detector from a corresponding display in a case where the difference is smaller than the first predetermined value.

7. The image pickup apparatus according to claim 1, further comprising a setting unit configured to set the first predetermined value according to a user operation.

8. The image pickup apparatus according to claim 1, further comprising:
an adjuster configured to adjust the first optical system or the second optical system; and
a switch configured to switch a mode of the image pickup apparatus to an adjustment mode for causing the adjuster to perform an adjustment,
wherein in a case where the mode of the image pickup apparatus is switched to the adjustment mode while the alert is being issued, the adjuster performs the adjustment based on the difference.

9. The image pickup apparatus according to claim 1, wherein the alert unit issues the alert in a case where the defocus amount of the first optical system or the defocus amount of the second optical system is smaller than a third predetermined value.

10. The image pickup apparatus according to claim 9, wherein at least one of the first predetermined value and the third predetermined value is set according to a state of the image pickup apparatus.

11. The image pickup apparatus according to claim 1, wherein the alert unit issues the alert by changing a display of at least one of a focus detecting area of the first focus detector and a focus detecting area of the second focus detector.

12. The image pickup apparatus according to claim 11, wherein the alert unit issues the alert by changing a color of the at least one.

13. The image pickup apparatus according to claim 11, wherein the alert unit issues the alert by blinking the at least one.

14. A control method comprising the steps of:
determining whether a difference between a defocus amount of a first optical system and a defocus amount of a second optical system is larger than a threshold, the first optical system and the second optical system being used for an image pickup apparatus; and
issuing an alert in a case where the difference is larger than the threshold.

15. A control method comprising the steps of:
determining whether a difference between a defocus amount of a first optical system and a defocus amount of a second optical system is larger than a threshold, the first optical system and the second optical system being used for an image pickup apparatus; and
reducing the difference by driving at least part of an imaging unit in a case where the difference is larger than the threshold.

16. A non-transitory computer-readable storage medium storing a program that causes a computer to execute the control method according to claim 14.

17. A non-transitory computer-readable storage medium storing a program that causes a computer to execute the control method according to claim 15.
